(19) United States
(12) Patent Application Publication
(10) Pub. No.: US 2025/0278499 A1
(43) Pub. Date: Sep. 4, 2025

(54) METHODS AND SYSTEMS FOR COMMUNICATING MESSAGES ON AN ELECTRONIC DEVICE

(71) Applicant: LEXMARK INTERNATIONAL, INC., LEXINGTON, KY (US)

(72) Inventors: TIMOTHY JOHN RADEMACHER, RICHMOND, KY (US); JENNIFER TOPMILLER WILLIAMS, LEXINGTON, KY (US)

(21) Appl. No.: 19/065,349

(22) Filed: Feb. 27, 2025

Related U.S. Application Data
(60) Provisional application No. 63/559,775, filed on Feb. 29, 2024.

(51) Int. Cl. G06F 21/60; H04L 1/18; H04L 9/06; H04L 47/34

(52) U.S. Cl. CPC G06F 21/608; G06F 21/602; H04L 9/0643; H04L 47/34; H04L 1/18

(57) ABSTRACT

A method of communicating messages between a first component of an imaging system and a second component of the imaging system within a communication session. The method comprises initialising a sequence number at the first component and at the second component at the beginning of the communication session. The method further comprises, for each message communicated in the communication session: when the message is a command message, incrementing a value of the sequence number at the first component and at the second component, communicating a packet comprising the message between the first component and the second component, and, when the message is encrypted, an indication of the sequence number. The value of the sequence number is unique for each command message in the communication session. An imaging device comprising a first component, the first component configured to communicate messages within a communication session between the first component and a second component, when the second component is installed in the imaging device. The first component is configured to: initialise a sequence number at the first component at the beginning of the communication session. The first component is further configured to: for each message communicated in the communication session: when the message is a command message, incrementing a value of the sequence number at the first component. The first component is further configured to: communicating a packet comprising the message between the first component and the second component, and, when the message is encrypted, an indication of the sequence number. The value of the sequence number is unique for each command message in the communication session. A supply item for an imaging device, the supply item comprising a second component, the second component configured to communicate messages within a communication session between the second component and a first component of the imaging device, when the second component is installed in the imaging device. The second component is configured to communicate messages within a communication session by: initialising a sequence number at the second component at the beginning of the communication session. The second component is further configured to, for each message communicated in the communication session: when the message is a command message, incrementing a value of the sequence number at the second component, communicating a packet comprising the message between the first component and the second component, and, when the message is encrypted, an indication of the sequence number. The value of the sequence number is unique for each command message in the communication session.

### CROSS REFERENCE TO RELATED APPLICATIONS

None.

### BACKGROUND

### 1. Technical Field

The present disclosure generally relates to methods, devices and systems for communicating data in the form of messages, on an electronic device, and, more particularly, methods, devices and systems for communicating messages on an imaging device.

### 2. Description of the Related Art

In electronic systems, it is often desirable to confirm the authenticity of a component of the electronic system to ensure that the entire system operates as designed. Non-authentic components employ various techniques to mimic the behavior of authentic components. This may include copying the authentic component's circuits and memory contents in order to duplicate authentication algorithms or encrypted communication between the component and the rest of the electronic system. This is particularly important in printing systems where it is desirable to confirm the authenticity of a supply component of the printing system to ensure correct operation.

In order to ensure the use of authentic components in an electronic device, it is desirable to more robustly protect data communicated between components. Accordingly, there is a need for improved systems and methods for communicating data in electronic devices.

### SUMMARY

The present disclosure provides example methods and systems that may be implemented in any general electronic system or specifically in an imaging/printing device/system to thwart the use of non-authentic components.

There is provided a method of communicating a message between a first component of an imaging system and a second component of the imaging system, the method comprising: determining whether a length of the message is equal to or greater than a threshold length, when the length of the message is equal to or greater than the threshold length, communicating the message encrypted between the first and second components of the imaging system, and when the length of the message is smaller than the threshold length, communicating the message unencrypted between the first and second components of the imaging system.

The term message includes all communications such as commands, responses, error messages and other data communicated between the first and second components. Communicating the message between the first and second components encompasses the actions of (i) sending from the first component to the second component, and/or (ii) sending from the second component to the first component, and/or (iii) receiving from the first component at the second component and/or (iv) receiving from the second component at the first component.

Communicating the message encrypted may comprise encrypting the message, sending the message from a first component to the second component, receiving the message at the second component from the first component, and unencrypting the message at the second component. Communicating the message unencrypted may comprise sending the message unencrypted from a first component to the second component and receiving the unencrypted message at the second component from the first component.

Error messages may be sent unencrypted as they may be of a length less than the threshold length.

The term sending may encompass making available for reading. For example, the second component may send the message to the first component by making the message available for the first component to read. The second component may be a peripheral and/or follower component.

In certain implementations, when the message is communicated unencrypted, an unencrypted packet is communicated, the packet comprising the message and, optionally, an error detecting code. Error detecting code may comprise a checksum, for example a cyclic redundancy check (CRC). The checksum may be of the message or may be of the rest of the packet.

In certain implementations, when the unencrypted packet is sent from the second component, the unencrypted packet further comprises a length field indicating the length of the message.

In certain implementations, when the message is sent encrypted, an encrypted packet is sent, the encrypted packet comprising encrypted data, such as encrypted blocks, based on the message and, optionally, an error detecting code. The encrypted packet may further comprise a message authentication code.

In certain implementations, when the encrypted packet is sent from the second component, the encrypted packet further comprises a length field indicating the length of the encrypted data. The length field may indicate the length of the encrypted data and any message authentication code present. This is considered to indicate the length of the message indirectly.

In certain implementations, when a sending component of the first and second component for the message, determines that the message to be communicated requires encryption and, optionally, determines the message has a length below the threshold length, the sending component performs a padding operation on the message, optionally to increase the length of the message to a padded length equal to or greater than the threshold length. The padding scheme may additionally or alternatively increase the length of the message to a length permitted by the encryption technique to be implemented, for example AES. In certain implementations, the sending component performs a padding operation on the message for every message that is to be communicated encrypted.

In certain implementations, a receiving component of the first and second component for the message, determines that the message communicated contains padding and performs an inverse of the padding operation on the message. In the case that the message contains padding, the length of the unpadded message within the encrypted data is determined by the receiving component by performing the inverse padding operation. In certain implementations, the receiving component performs the inverse of the padding operation on the message for every message that is encrypted. In this case, determining that the message contains padding may comprise determining that the message is encrypted.

There is further provided a method of communicating a message in a packet between a first component of an imaging system and a second component of the imaging system, the method comprising: when the packet is sent from the second component, the packet comprises the message and a length field indicating the length of the message. There is further provided, an imaging device comprising a first component, the first component configured to communicate a message in a packet between the first component and a second component, when the second component is installed in the imaging device, and when the packet is sent from the second component, the packet comprises the message and a length field indicating the length of the message. There is further provided, a supply item for an imaging device, the supply item comprising a second component, the second component configured to communicate a message in a packet between the second component and a first component of the imaging device, when the second component is installed in the imaging device and when the packet is sent from the second component, the packet comprises the message and a length field indicating the length of the message.

There is further provided, an imaging device comprising a first component, the first component configured to communicate a message in a packet between the first component and a second component, when the second component is installed in the imaging device, wherein the first component is configured to communicate a message in a packet by: determining whether a length of the message is equal to or greater than a threshold length, when the length of the message is equal to or greater than the threshold length, communicating the message encrypted, and when the length of the message is smaller than the threshold length, communicating the message unencrypted.

In certain implementations, when the message is communicated unencrypted, an unencrypted packet is sent, the packet comprising the message and, optionally, an error detecting code.

In certain implementations, when an unencrypted packet is received at the first component from the second component, the first component is configured to determine a length of the message by reading a length field of the unencrypted packet.

In certain implementations, when the message is communicated encrypted, an encrypted packet is communicated, the encrypted packet comprising encrypted data, such as encrypted blocks, based on the message and, optionally, an error detecting code.

In certain implementations, when the encrypted packet is received at the first component from the second component, the first component is configured to determine a length of the encrypted data of the encrypted packet by reading a length field of the encrypted packet.

In certain implementations, when the first component is to send the message and the message has a length below the threshold length, the first component is configured to determine whether the message requires encryption and, when it is determined that the message does require encryption, the first component is configured to perform a padding operation on the message to increase the length of the message to a padded length equal to or greater than the threshold length. In certain implementations, when the first component receives the message, the first component is configured to determine whether the message contains padding and, when it is determined that the message does contain padding, the first component is configured to perform an inverse of the padding operation on the message.

There is further provided, a supply item for an imaging device, the supply item comprising a second component, the second component configured to communicate a message in a packet between the second component and a first component of the imaging device, when the second component is installed in the imaging device, wherein the second component is configured to communicate a message in a packet by: determining whether a length of the message is equal to or greater than a threshold length, when the length of the message is equal to or greater than the threshold length, communicating the message encrypted, and when the length of the message is smaller than the threshold length, communicating the message unencrypted.

In certain implementations, when the message is communicated unencrypted, an unencrypted packet is communicated, the packet comprising the message and, optionally, an error detecting code.

In certain implementations, when the unencrypted packet is sent from the second component, the second component is configured to include in the packet, a length field indicating the length of the message.

In certain implementations, when the message is sent encrypted, an encrypted packet is communicated, the encrypted packet comprising encrypted data, such as encrypted blocks, based on the message and, optionally, an error detecting code.

In certain implementations, when the encrypted packet is sent from the second component, the second component is configured to include in the packet a length field indicating the length of the encrypted data.

In certain implementations, when the second component is to send the message and the message has a length below the threshold length, the second component is configured to determine whether the message requires encryption and, when it is determined that the message does require encryption, the second component is configured to perform a padding operation on the message to increase the length of the message to a padded length equal to or greater than the threshold length. In certain implementations, when the second component receives the message, the second component is configured to determine whether the message contains padding and, when it is determined that the message does contain padding, the second component is configured to perform an inverse padding operation on the message, for example, an inverse of the padding operation.

There is further provided an imaging system comprising a supply item as described above installed in an imaging device as described above.

There is further provided a method of communicating messages between a first component of an imaging system and a second component of the imaging system within a communication session, the method comprising: initialising a sequence number at the first component and at the second component at the beginning of the communication session, for each message communicated in the communication session: when the message is a command message, incrementing a value of the sequence number at the first component and at the second component, communicating a packet comprising the message between the first component and the second component, and, when the message is encrypted, an indication of the sequence number, wherein the value of the sequence number is unique for each command message in the communication session.

The term initialising encompasses storing or setting a value for the sequence number at an initial number, for example, 0. A session key may be established at the beginning of the communication session. The session key may be unique to the session. To ensure the session key is not used for too long, a limit is set on how many packets can be sent before requiring a new session be established. The sequence number is used to track the number of packets per session, and the sequence number is reset whenever a new session is established.

A command message may be defined as a message sent from the first component to the second component, wherein the message is not an error message or a resend of a previously sent message.

The incrementing of the value of the sequence number is the same at the first and second components. For example, incrementing may add 1 to the value, or increment the sequence number along another predetermined sequence.

In certain implementations, when an error occurs in communicating one of the packets to the second component, an error message is sent to the first component, and the first component resends the packet to the second component. When the first component receives the error generated by the second component, the first component knows that the second component did not receive the command properly so the first component can send the command/message again.

In certain implementations, when an error occurs in communicating one of the packets to the first component, the first component sends the second component a resend request for the packet, the resend request comprising an indication of whether the sequence number at the first component is odd or even. By the first component not being able to properly read the response from the second component, the first component does not know if the second component properly received the command or if the second component also had a communication failure and has not received the command yet. If the second component properly received the command, it would have executed the command, prepared the response, and incremented the sequence number. If the second component did not properly receive the command, it would have prepared an error response and not have incremented the sequence number. Initially the first component assumes the second component has received the command and executed on it already, so it sends a Resend request and sequence even/odd based on the command already being executed.

In certain implementations, when the indication of whether the sequence number is odd or even matches the sequence number at the second component, the second component resends the packet to the first component. When the second component received the original command without error and executed it, the sequence even/odd in the resend request should match what the second component expects, so the second component will send its last response again without re-executing the command.

In certain implementations, when the indication of whether the sequence number is odd or even does not match the sequence number at the second component, the second component sends a sequence error message to the first component and the first component resends the last command packet sent from the first component to the second component prior to the error. When the second component did not receive the original command properly, the sequence even/odd should not match. In this case, the second component responds with a sequence error to notify the first component that it never properly received the original command. When the first component receives the sequence error from the second component, the first component knows that the second component also had a communication failure on the original command, so it needs to send the original command again.

When the indication states that the sequence number is odd and the sequence number at the second component is odd, or when the sequence number is even and the sequence number at the second component is even, the indication matches the sequence number. A sequence error may be referred to as a cycle error.

In certain implementations, the sequence number is not incremented at the first component when the command is resent to the second component.

In certain implementations, the error message is sent unencrypted.

In certain implementations the resend request and sequence error message are sent unencrypted.

In certain implementations, the indication of the sequence number may be the sequence number itself or a coded version of the number. In certain implementations, for messages that are encrypted, the indication of the sequence number comprises a Message Authentication Code (MAC) based on the sequence number and the message.

In certain implementations, the MAC is further based on a MAC key. In certain implementations, the MAC is calculated using the MAC key on the message with appended sequence number. In certain implementations, the MAC is calculated by performing a hash, HMAC, KMAC, UMAC, or Poly1305. In certain implementations, the MAC key may comprise an authentication key used in authentication encryption. The MAC may comprise an authentication tag produced by an authenticated encryption.

In certain implementations, the MAC key comprises a portion of the session key and/or the sequence number. In this way, calculated MAC is different even if the unencrypted data is the same between packets due to the sequence number being different for each packet. In certain implementations, the MAC is a one-way function. This means there is no way to directly calculate the sequence number for a given MAC. However, the components can calculate the MAC for their stored sequence number and determine if the stored sequence number matches the sequence number used of the MAC. When the MAC is validly decoded, this confirms the sender and receiver have the same sequence number. Use of the MAC helps determine sequence errors, but also helps in detection of non-authentic components.

In certain implementations, encryption of the packet utilises an encryption algorithm utilising an encryption key. In certain implementations, the encryption key comprises portion of the session key and the sequence number.

In certain implementations, the sequence number comprises 16 bits. A 16-bit sequence number allows 65536 unique values and so up to 65536 command messages in a single session. In certain implementations, the method further comprises ending the communication session when the sequence number reaches a maximum value of the sequence number. Once a communication session has been ended, a new communication session is established. The sequence number then reinitialises, for example, to 0. This means that the sequence number does not roll over to 0 and a new session key is generated before a sequence number is reused.

There is further provided an imaging device comprising a first component, the first component configured to communicate messages within a communication session between the first component and a second component, when the second component is installed in the imaging device, the first component configured to: initialise a sequence number at the first component at the beginning of the communication session, for each message communicated in the communication session: when the message is a command message, incrementing a value of the sequence number at the first component, communicating a packet comprising the message between the first component and the second component, and, when the message is encrypted, an indication of the sequence number, wherein the value of the sequence number is unique for each command message in the communication session.

In certain implementations, when the first component receives an error message from the second component, the first component is configured to resend the packet to the second component.

In certain implementations, when an error occurs in communicating one of the packets to the first component, the first component is configured to send the second component a resend request for the packet, the resend request comprising an indication of whether the sequence number is odd or even.

In certain implementations, when the first component receives a sequence error message, the first component is configured to resend the last command packet sent by the first component to the second component prior to the error.

In certain implementations, the first component configured to end the communication session when the sequence number reaches a maximum value of the sequence number.

There is further provided a supply item for an imaging device, the supply item comprising a second component, the second component configured to communicate messages within a communication session between the second component and a first component of the imaging device, when the second component is installed in the imaging device, wherein the second component is configured to communicate messages within a communication session by: initialising a sequence number at the second component at the beginning of the communication session, for each message communicated in the communication session: when the message is a command message, incrementing a value of the sequence number at the second component, communicating a packet comprising the message between the first component and the second component, and, when the message is encrypted, an indication of the sequence number, wherein the value of the sequence number is unique for each command message in the communication session.

In certain implementations, the second component is configured to: send an error message to the first component when an error occurs in communicating one of the packets to the second component, and/or determine whether an indication of whether the sequence number is odd or even matches the sequence number at the second component, when the second component receives a resend request for the packet, the resend request comprising the indication of whether the sequence number is odd or even, and, resend the packet to the first component when the indication of whether the sequence number is odd or even is determined to match the sequence number at the second component, and send a sequence error message to the first component when the indication of whether the sequence number is odd or even does not match the sequence number at the second component.

There is further provided an imaging system comprising a supply item as described above installed in an imaging device as described above.

There is further provided a method of communicating a message between a first component of an electronic system and a second component of the electronic system, the method comprising: determining whether a length of the message is equal to or greater than a threshold length, when the length of the message is equal to or greater than the threshold length, communicating the message encrypted between the first and second components of the electronic system, and when the length of the message is smaller than the threshold length, communicating the message unencrypted between the first and second components of the electronic system.

Communicating the message encrypted may comprise encrypting the message, sending the message from a first component to the second component, receiving the message at the second component from the first component, and unencrypting the message at the second component. Communicating the message unencrypted may comprise sending the message unencrypted from a first component to the second component and receiving the unencrypted message at the second component from the first component.

Error messages may be sent unencrypted as they may be of a length less than the threshold length.

The term sending may encompass making available for reading. For example, the second component may send the message to the first component by making the message available for the first component to read. The second component may be a peripheral and/or follower component.

In certain implementations, when the message is communicated unencrypted, an unencrypted packet is communicated, the packet comprising the message and, optionally, an error detecting code. Error detecting code may comprise a checksum, for example a cyclic redundancy check (CRC). The checksum may be of the message or may be of the rest of the packet.

In certain implementations, when the unencrypted packet is sent from the second component, the unencrypted packet further comprises a length field indicating the length of the message.

In certain implementations, when the message is sent encrypted, an encrypted packet is sent, the encrypted packet comprising encrypted data, such as encrypted blocks, based on the message and, optionally, an error detecting code. The encrypted packet may further comprise a message authentication code.

In certain implementations, when the encrypted packet is sent from the second component, the encrypted packet further comprises a length field indicating the length of the encrypted data. The length field may indicate the length of the encrypted data and any message authentication code present. This is considered to indicate the length of the message indirectly.

In certain implementations, when a sending component of the first and second component for the message, determines that the message to be communicated requires encryption and, optionally, determines the message has a length below the threshold length, the sending component performs a padding operation on the message, optionally to increase the length of the message to a padded length equal to or greater than the threshold length. The padding scheme may additionally or alternatively increase the length of the message to a length permitted by the encryption technique to be implemented, for example AES. In certain implementations, the sending component performs a padding operation on the message for every message that is to be communicated encrypted.

In certain implementations, a receiving component of the first and second component for the message, determines that the message communicated contains padding and performs an inverse of the padding operation on the message. In the case that the message contains padding, the length of the unpadded message within the encrypted data is determined by the receiving component by performing the inverse padding operation. In certain implementations, the receiving component performs the inverse of the padding operation on the message for every message that is encrypted. In this case, determining that the message contains padding may comprise determining that the message is encrypted.

There is further provided a method of communicating a message in a packet between a first component of an electronic system and a second component of the electronic system, the method comprising: when the packet is sent from the second component, the packet comprises the message and a length field indicating the length of the message. There is further provided, an electronic device comprising a first component, the first component configured to communicate a message in a packet between the first component and a second component, when the second component is installed in the electronic device, and when the packet is sent from the second component, the packet comprises the message and a length field indicating the length of the message. There is further provided, a supply component for an electronic device, the supply component comprising a second component, the second component configured to communicate a message in a packet between the second component and a first component of the electronic device, when the second component is installed in the electronic device and when the packet is sent from the second component, the packet comprises the message and a length field indicating the length of the message.

There is further provided, an electronic device comprising a first component, the first component configured to communicate a message in a packet between the first component and a second component, when the second component is installed in the electronic device, wherein the first component is configured to communicate a message in a packet by: determining whether a length of the message is equal to or greater than a threshold length, when the length of the message is equal to or greater than the threshold length, communicating the message encrypted, and when the length of the message is smaller than the threshold length, communicating the message unencrypted.

In certain implementations, when the message is communicated unencrypted, an unencrypted packet is sent, the packet comprising the message and, optionally, an error detecting code.

In certain implementations, when an unencrypted packet is received at the first component from the second component, the first component is configured to determine a length of the message by reading a length field of the unencrypted packet.

In certain implementations, when the message is communicated encrypted, an encrypted packet is communicated, the encrypted packet comprising encrypted data, such as encrypted blocks, based on the message and, optionally, an error detecting code.

In certain implementations, when the encrypted packet is received at the first component from the second component, the first component is configured to determine a length of the encrypted data of the encrypted packet by reading a length field of the encrypted packet.

In certain implementations, when the first component is to send the message and the message has a length below the threshold length, the first component is configured to determine whether the message requires encryption and, when it is determined that the message does require encryption, the first component is configured to perform a padding operation on the message to increase the length of the message to a padded length equal to or greater than the threshold length. In certain implementations, when the first component receives the message, the first component is configured to determine whether the message contains padding and, when it is determined that the message does contain padding, the first component is configured to perform an inverse of the padding operation on the message.

There is further provided, a supply component for an electronic device, the supply component comprising a second component, the second component configured to communicate a message in a packet between the second component and a first component of the electronic device, when the second component is installed in the electronic device, wherein the second component is configured to communicate a message in a packet by: determining whether a length of the message is equal to or greater than a threshold length, when the length of the message is equal to or greater than the threshold length, communicating the message encrypted, and when the length of the message is smaller than the threshold length, communicating the message unencrypted.

In certain implementations, when the message is communicated unencrypted, an unencrypted packet is communicated, the packet comprising the message and, optionally, an error detecting code.

In certain implementations, when the unencrypted packet is sent from the second component, the second component is configured to include in the packet, a length field indicating the length of the message.

In certain implementations, when the message is sent encrypted, an encrypted packet is communicated, the encrypted packet comprising encrypted data, such as encrypted blocks, based on the message and, optionally, an error detecting code.

In certain implementations, when the encrypted packet is sent from the second component, the second component is configured to include in the packet a length field indicating the length of the encrypted data.

In certain implementations, when the second component is to send the message and the message has a length below the threshold length, the second component is configured to determine whether the message requires encryption and, when it is determined that the message does require encryption, the second component is configured to perform a padding operation on the message to increase the length of the message to a padded length equal to or greater than the threshold length. In certain implementations, when the second component receives the message, the second component is configured to determine whether the message contains padding and, when it is determined that the message does contain padding, the second component is configured to perform an inverse padding operation on the message, for example, an inverse of the padding operation.

There is further provided an electronic system comprising a supply component as described above installed in an electronic device as described above.

There is further provided a method of communicating messages between a first component of an electronic system and a second component of the electronic system within a communication session, the method comprising: initialising a sequence number at the first component and at the second component at the beginning of the communication session, for each message communicated in the communication session: when the message is a command message, incrementing a value of the sequence number at the first component and at the second component, communicating a packet comprising the message between the first component and the second component, and, when the message is encrypted, an indication of the sequence number, wherein the value of the sequence number is unique for each command message in the communication session.

The term initialising encompasses storing or setting a value for the sequence number at an initial number, for example, 0. A session key may be established at the beginning of the communication session. The session key may be unique to the session. To ensure the session key is not used for too long, a limit is set on how many packets can be sent before requiring a new session be established. The sequence number is used to track the number of packets per session, and the sequence number is reset whenever a new session is established.

A command message may be defined as a message sent from the first component to the second component, wherein the message is not an error message or a resend of a previously sent message.

The incrementing of the value of the sequence number is the same at the first and second components. For example, incrementing may add 1 to the value, or increment the sequence number along another predetermined sequence.

In certain implementations, when an error occurs in communicating one of the packets to the second component, an error message is sent to the first component, and the first component resends the packet to the second component. When the first component receives the error generated by the second component, the first component knows that the second component did not receive the command properly so the first component can send the command/message again.

In certain implementations, when an error occurs in communicating one of the packets to the first component, the first component sends the second component a resend request for the packet, the resend request comprising an indication of whether the sequence number at the first component is odd or even. By the first component not being able to properly read the response from the second component, the first component does not know if the second component properly received the command or if the second component also had a communication failure and has not received the command yet. If the second component properly received the command, it would have executed the command, prepared the response, and incremented the sequence number. If the second component did not properly receive the command, it would have prepared an error response and not have incremented the sequence number. Initially the first component assumes the second component has received the command and executed on it already, so it sends a Resend request and sequence even/odd based on the command already being executed.

In certain implementations, when the indication of whether the sequence number is odd or even matches the sequence number at the second component, the second component resends the packet to the first component. When the second component received the original command without error and executed it, the sequence even/odd in the resend request should match what the second component expects, so the second component will send its last response again without re-executing the command.

In certain implementations, when the indication of whether the sequence number is odd or even does not match the sequence number at the second component, the second component sends a sequence error message to the first component and the first component resends the last command packet sent from the first component to the second component prior to the error. When the second component did not receive the original command properly, the sequence even/odd should not match. In this case, the second component responds with a sequence error to notify the first component that it never properly received the original command. When the first component receives the sequence error from the second component, the first component knows that the second component also had a communication failure on the original command, so it needs to send the original command again.

When the indication states that the sequence number is odd and the sequence number at the second component is odd, or when the sequence number is even and the sequence number at the second component is even, the indication matches the sequence number. A sequence error may be referred to as a cycle error.

In certain implementations, the sequence number is not incremented at the first component when the command is resent to the second component.

In certain implementations, the error message is sent unencrypted.

In certain implementations the resend request and sequence error message are sent unencrypted.

In certain implementations, the indication of the sequence number may be the sequence number itself or a coded version of the number. In certain implementations, for messages that are encrypted, the indication of the sequence number comprises a Message Authentication Code (MAC) based on the sequence number and the message.

In certain implementations, the MAC is further based on a MAC key. In certain implementations, the MAC is calculated using the MAC key on the message with appended sequence number. In certain implementations, the MAC is calculated by performing a hash, HMAC, KMAC, UMAC, or Poly1305. In certain implementations, the MAC key may comprise an authentication key used in authentication encryption. The MAC may comprise an authentication tag produced by an authenticated encryption.

In certain implementations, the MAC key comprises a portion of the session key and/or the sequence number. In this way, calculated MAC is different even if the unencrypted data is the same between packets due to the sequence number being different for each packet. In certain implementations, the MAC is a one-way function. This means there is no way to directly calculate the sequence number for a given MAC. However, the components can calculate the MAC for their stored sequence number and determine if the stored sequence number matches the sequence number used of the MAC. When the MAC is validly decoded, this confirms the sender and receiver have the same sequence number. Use of the MAC helps determine sequence errors, but also helps in detection of non-authentic components.

In certain implementations, encryption of the packet utilises an encryption algorithm utilising an encryption key. In certain implementations, the encryption key comprises portion of the session key and the sequence number.

In certain implementations, the sequence number comprises 16 bits. A 16-bit sequence number allows 65536 unique values and so up to 65536 command messages in a single session. In certain implementations, the method further comprises ending the communication session when the sequence number reaches a maximum value of the sequence number. Once a communication session has been ended, a new communication session is established. The sequence number then reinitialises, for example, to 0. This means that the sequence number does not roll over to 0 and a new session key is generated before a sequence number is reused.

There is further provided an electronic device comprising a first component, the first component configured to communicate messages within a communication session between the first component and a second component, when the second component is installed in the electronic device, the first component configured to: initialise a sequence number at the first component at the beginning of the communication session, for each message communicated in the communication session: when the message is a command message, incrementing a value of the sequence number at the first component, communicating a packet comprising the message between the first component and the second component, and, when the message is encrypted, an indication of the sequence number, wherein the value of the sequence number is unique for each command message in the communication session.

In certain implementations, when the first component receives an error message from the second component, the first component is configured to resend the packet to the second component.

In certain implementations, when an error occurs in communicating one of the packets to the first component, the first component is configured to send the second component a resend request for the packet, the resend request comprising an indication of whether the sequence number is odd or even.

In certain implementations, when the first component receives a sequence error message, the first component is configured to resend the last command packet sent by the first component to the second component prior to the error.

In certain implementations, the first component configured to end the communication session when the sequence number reaches a maximum value of the sequence number.

There is further provided a supply component for an electronic device, the supply component comprising a second component, the second component configured to communicate messages within a communication session between the second component and a first component of the electronic device, when the second component is installed in the electronic device, wherein the second component is configured to communicate messages within a communication session by: initialising a sequence number at the second component at the beginning of the communication session, for each message communicated in the communication session: when the message is a command message, incrementing a value of the sequence number at the second component, communicating a packet comprising the message between the first component and the second component, and, when the message is encrypted, an indication of the sequence number, wherein the value of the sequence number is unique for each command message in the communication session.

In certain implementations, the second component is configured to: send an error message to the first component when an error occurs in communicating one of the packets to the second component, and/or determine whether an indication of whether the sequence number is odd or even matches the sequence number at the second component, when the second component receives a resend request for the packet, the resend request comprising the indication of whether the sequence number is odd or even, and, resend the packet to the first component when the indication of whether the sequence number is odd or even is determined to match the sequence number at the second component, and send a sequence error message to the first component when the indication of whether the sequence number is odd or even does not match the sequence number at the second component.

There is further provided an electronic system comprising a supply component as described above installed in an electronic device as described above.

In this specification, components ‘of’ an imaging device or electronic device may be removable parts, such as supply items or components, installed in the imaging/electronic device or may be inherent component parts of the imaging/electronic device. The term imaging/electronic system is used to describe a system comprising an imaging/electronic device and installed removable parts, such as one or more supply items/components.

In any of the implementations/embodiments described herein, the components may be connected via any communication protocol, such as a shared bus, such as I2C or peer-to-peer.

The methods, devices, supply items and systems described above may be employed in any combination. The optional features described above are equally applicable to all of the described methods, devices, supply items and systems and are not limited to the particular method/device/supply item/system with which they are described. The essential features of any of the methods, devices, supply items and systems described may be optional features of any other methods, devices, supply items and systems described.

From the foregoing disclosure and the following detailed description of various examples, it will be apparent to those skilled in the art that the present disclosure provides a significant advance in the art of communication between components an electronic system such as an imaging system. Additional features and advantages of various examples will be better understood in view of the detailed description provided below.

As used herein, the terms ‘leader’ and ‘controller’ are equivalent to the term ‘controller’ as used in the official I2C-bus specification and user manual, Rev. 7.0-1, October 2021, and can be used interchangeably throughout without changing the meaning. As used herein, the terms ‘follower’ and ‘peripheral’ are equivalent to the term ‘target’ as used in the official I2C-bus specification and can be used interchangeably throughout without changing the meaning. Both terms ‘controller’ and ‘target’ take their usual meanings in the art, for example, as used in the official I2C-bus specification.

### BRIEF DESCRIPTION OF THE DRAWINGS

The above-mentioned and other features and advantages of the present disclosure, and the manner of attaining them, will become more apparent and will be better understood by reference to the following description of examples taken in conjunction with the accompanying drawings. Like reference numerals are used to indicate the same element throughout the specification.

FIG. 1 is a diagrammatic view of an imaging system.

FIGS. 2A to 2D are diagrams showing the components of packets used in communicating a message between a first component of an imaging system and a second component of the imaging system.

FIG. 3 is a diagram showing a method of communicating a message between a first component of an imaging system and a second component of the imaging system.

FIG. 4 is a diagram showing a method of communicating a message between a first component of an imaging system and a second component of the imaging system.

FIG. 5 is a diagram showing a method of communicating a message between a first component of an imaging system and a second component of the imaging system.

FIG. 6 is a diagram showing a method of communicating a message between a first component of an imaging system and a second component of the imaging system.

### DETAILED DESCRIPTION OF THE DRAWINGS

It is to be understood that the disclosure is not limited to the details of construction and the arrangement of components set forth in the following description or illustrated in the drawings. The disclosure is capable of other examples and of being practiced or of being carried out in various ways. For example, other examples may incorporate structural, chronological, process, and other changes. Examples merely typify possible variations. Individual components and functions are optional unless explicitly required, and the sequence of operations may vary. Portions and features of some examples may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

It will be further understood that the methods, may be implemented by computer program instructions. These computer program instructions may be loaded onto a general-purpose computer, special purpose computer, or other programmable data processing apparatus to produce a machine, such that the instructions which execute on the computer or other programmable data processing apparatus may create means for implementing the functionality of each block or combinations of blocks in the flow charts discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the flow charts support combinations of means for performing the specified functions, combinations of steps for performing the specified functions and program instruction means for performing the specified functions. It will also be understood that each block of the flow charts, and combinations of blocks in the flow charts, can be implemented by special purpose hardware-based computer systems that perform the specified functions or steps or combinations of special purpose hardware and computer instructions.

Disclosed are example systems and methods for communicating data in the form of messages in an electronic system, such as an imaging/printer system.

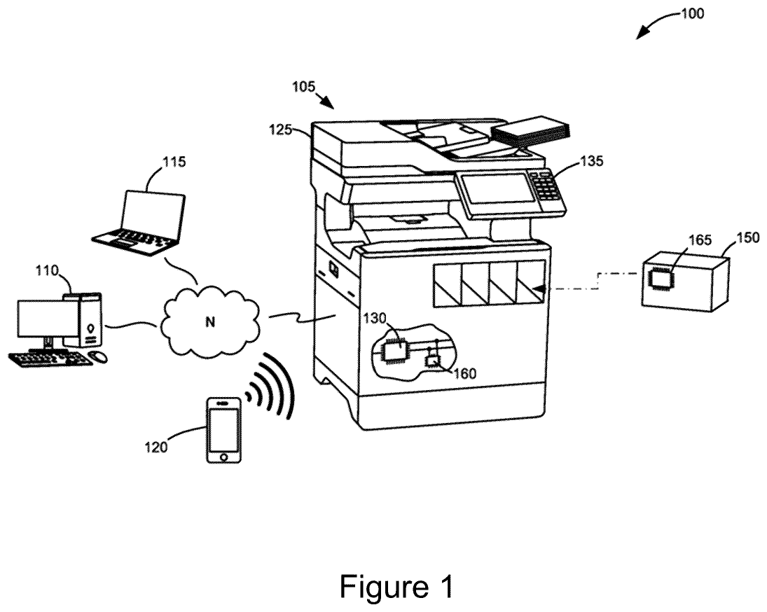

Referring to FIG. 1, there is shown a diagrammatic view of an imaging system 100 used in association with the present disclosure. Imaging system 100 includes an imaging device 105 used for printing images on sheets of media. Image data of the image to be printed on a media sheet may be supplied to imaging device 105 from a variety of sources such as a computer 110, laptop 115, mobile device 120, scanner 125 of the imaging device 105, or like computing device. The sources directly or indirectly communicate with imaging device 105 via wired and/or wireless connections.

Imaging device 105 includes an imaging device component 130 and a user interface 135. Imaging device component 130 may include a processor and associated memory. In some examples, imaging device component 130 may be formed as one or more Application Specific Integrated Circuits (ASICs) or System-on-Chip (SoCs). Memory may be any memory device which stores data and may be used with or capable of communicating with processor. For example, memory may be any volatile or non-volatile memory or combination thereof such as, for example, random access memory (RAM), read-only memory (ROM), flash memory and/or non-volatile RAM (NVRAM) for storing data. Optionally, imaging device component 130 may control the processing of print data. Optionally, imaging device component 130 may also control the operation of a print engine during printing of an image onto a sheet of media.

In one example, imaging device 105 may employ an electronic authentication scheme to authenticate consumable supply items and/or replaceable units installed in imaging device 105. In FIG. 1, a representative consumable supply item/replaceable item, such as a toner cartridge 150, is shown (other consumable/replaceable supply items can equally be used in addition or instead, such as imaging units and fusers). Supply item 150 may be installed in a corresponding storage area in imaging device 105. To perform authentication of supply item 150, imaging device 105 may utilize an imaging device security device 160 incorporated in imaging device 105 and a supply item security device 165 of supply item 150.

Described below is a communications protocol that provides confidentiality, integrity and error correction with minimal overhead.

Communication takes place predominantly in communications established between a first and a second component. The first component in the below described examples is referred to as the controller and the second component as the peripheral, but it will be recognized that other types of components may be used without departing from the teaching of the disclosure.

Establishing a communication session comprises establishing a session key. Once the session key is established, commands may be sent encrypted or unencrypted.

A sequence number is initialised at the first component and at the second component at the beginning of the communication session. Then, for each message communicated in the communication session: when the message is a command message, the value of the sequence number at the first component and at the second component is incremented. The value of the sequence number is then unique for each command message in the communication session. When a message communicated in the session is encrypted, an indication of the sequence number is also communicated.

To initialise the sequence number, a value for the sequence number is set at an initial number, for example, 0 at each component. The incrementing of the value of the sequence number is the same at the first and second components, and in this example, each incrementation adds 1 to the value.

The sequence number is incremented on a successful transfer of a command message. The sequence number is unique for each command in a session. This means that the storage for the sequence number must be large enough to prevent wraparound to zero for the number of transactions (command messages) that can occur in one session. For example, if a 32-bit value is used for the sequence number then the session key is limited to 232 transactions (commands). The sequence number is set to 0 when a session is started.

In the preferred embodiment, a 16-bit value is used for the sequence number, so there is a maximum of 2¹⁶=65,536 transactions per session. The controller establishes a new session with the peripheral before the sequence number reaches 2¹⁶. The first command in the initialize session sequence is less than the threshold length of 32 bytes and is sent to the peripheral unencrypted. This first command puts the peripheral back in the uninitialized state and the rest of the initialize session sequence is unencrypted. Transitioning back to the uninitialized state is necessary to allow sending the commands unencrypted as some of the initialize session commands and responses are longer than 32 bytes.

Within a communication session, any unencrypted command must be less than a fixed threshold length. Within a communication session, any commands that are the threshold length or longer must be encrypted. This allows the peripheral to determine if a command is encrypted by determining the command length. Unless there is an error, responses to encrypted commands are also encrypted. An error response, such as for a CRC error, are sent unencrypted.

In the preferred embodiment, the threshold length is 32 bytes, which is the length of two AES blocks. The length of error responses is less than 32 bytes so the controller will know that they are unencrypted.

When a component sends a message, the component determines whether a length of the message is equal to or greater than a threshold length, and when the length of the message is equal to or greater than the threshold length, the component sends the message encrypted, and when the length of the message is smaller than the threshold length, the component sends the message unencrypted. Equally when a component receives a message, the component determines whether the length of the message is equal to or greater than a threshold length, and when the length of the message is equal to or greater than the threshold length, the component reads the message encrypted, for example by decrypting the message and then reading the decrypted message, and when the length of the message is smaller than the threshold length, the component reads the message unencrypted.

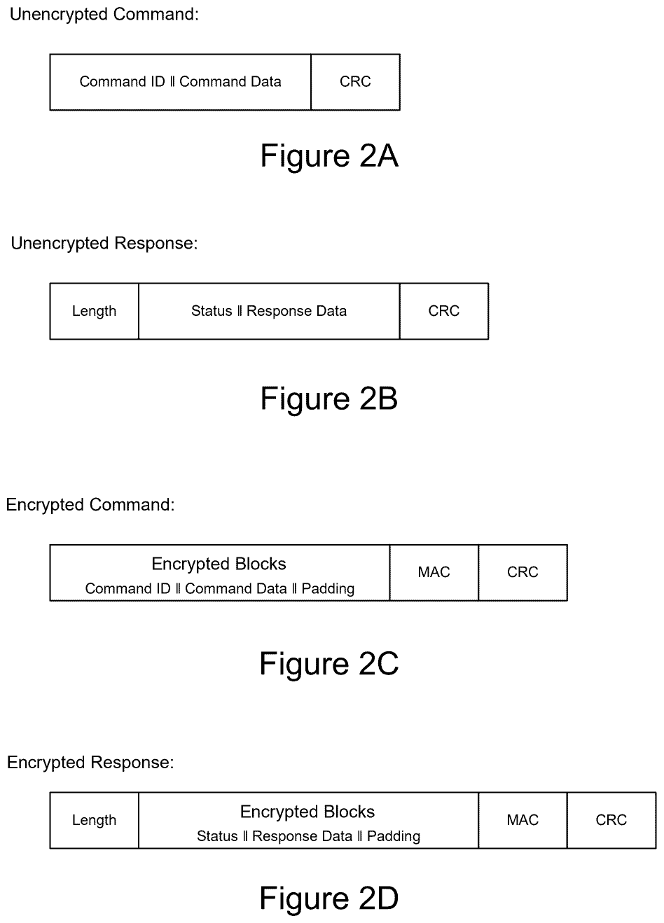

Example packet formats for communicating messages are shown in FIGS. 2A to 2D. The messages illustrated in the examples are the command id, command data, status, response data and padding. In these examples, the command id, status, and padding (for encrypted packets) are always present, but the command or response data may be zero bytes.

Only a limited set of commands are allowed to be sent unencrypted. The purpose of these unencrypted commands may include error recovery, key establishment, and presence detection. The device starts from power on or from reset in an uninitialized state. In the uninitialized state, only the set of unencrypted commands is accepted until a session key is established. A new key is used for each session and is established by the controller sending a sequence of unencrypted commands to the peripheral.

As shown in FIGS. 2A and 2B, when the message is communicated unencrypted, an unencrypted packet is communicated, the packet comprising the message. As shown in FIGS. 2C and 2D, when the message is sent encrypted, an encrypted packet is sent, the encrypted packet comprising encrypted blocks based on the message.

Most commands are encrypted for confidentiality. In the preferred embodiment, the commands are encrypted with a block cipher such as AES. As block ciphers operate on fixed length blocks, a padding scheme is used to pad the command and response data to a multiple of the block length. Alternatively, a stream cipher could be used. Encryption of the packet utilises an encryption algorithm utilising an encryption key. The encryption key comprises a portion of the session key and the sequence number.

When a sending component of the first and second component for the message, determines that the message to be communicated requires encryption and the message has a length below the threshold length, the sending component performs a padding operation on the message to increase the length of the message to a padded length equal to or greater than threshold length. Alternatively, or additionally, the padding operation increases the length of the message to a length permitted by the encryption technique to be implemented, for example AES.

A receiving component for the message, determines that the message communicated contains padding and performs an inverse of the padding operation on the message. In the case that the message contains padding, the length of the unpadded message within the encrypted blocks is determined by the receiving component by performing the inverse padding operation on the padded length indicated in the length field.

As shown in FIGS. 2A to 2D, each packet includes a cyclic redundancy check (CRC). The CRC is a CRC of the message and optionally the MAC and is located at the end of the packet (though it could appear at another position in other embodiments). A CRC is appended to each packet for error detection and correction. The CRC is appended after the MAC on encrypted packets or after the data for unencrypted packets. The CRC is fast to calculate and is sufficient for detecting most errors. The CRC is not secure against malicious behavior, so the MAC is needed to provide message authentication against possible attacks.

As shown in FIGS. 2B and 2D, when the packet is sent from the second component, the packet further comprises a length field stating the length of the message, or encrypted blocks and MAC code. The length of the encrypted blocks and MAC code is considered to indicate the length of the message indirectly.

In I2C, the controller acknowledges the bytes from the peripheral during a read. As a result, the controller does not know when the data from the peripheral ends. To solve this issue, the response from the peripheral starts with a length field that is sent unencrypted. The controller reads the length field and from it determines the number of following bytes to read.

In the preferred embodiment, the data may be up to 464 bytes in length. To fit the length in a single byte L, the following encoding is used for a packet with N bytes:

$$for N > 31 : L = 16 + N / 2 ,$$

$$for 0 \leq N \leq 31 : L = N ,$$

In other words, the value of L is the length of the packet for unencrypted packets or 16+N/2 for encrypted packets. This requires the length of all encrypted packets to be a multiple of 2 bytes. When in the uninitialized state (outside of a communication session), unencrypted packets larger than 31 bytes will set the length field based on 16+N/2 and may be a multiple of 2 bytes.

The value of L is 248 for the maximum length and values 249 to 255 (0xF9 to 0xFF) are used for special cases. The I2C bus is pulled high, so the controller reads 0xFF when the peripheral does not respond. In the preferred embodiment, values 249 to 254 are reserved for future use.

As shown in FIGS. 2C and 2D, encrypted packets further comprise a message authentication code (MAC) which increases communication integrity. The MAC could be one of a hash, HMAC, KMAC, UMAC, or Poly1305. The sequence number is used as a component of the MAC calculation. In particular, the MAC key comprises a portion of the session key and the sequence number. In this way, the calculated MAC is different even if the unencrypted data is the same between packets due to the sequence number being different for each packet. The MAC is a one-way function which means there is no way to directly calculate the sequence number for a given MAC. However, the components can calculate the MAC using their stored sequence number and thereby determine if the stored sequence number matches the sequence number used of the MAC.

Verification of the MAC then provides assurance that the controller and peripheral are in sync in addition to authentication of the data. Use of the MAC helps determine sequence errors, but also helps in detection of non-authentic components. For example, suppose the HMAC is used, and the message is the command data concatenated with the sequence number (∥ means concatenation).

$$MAC = HMAC ( MAC key , message data \vert \vert sequence number )$$

The sequence number is unique for each command/response in a session, so a valid MAC assures the receiver that its sequence number is the same as that of the transmitting device.

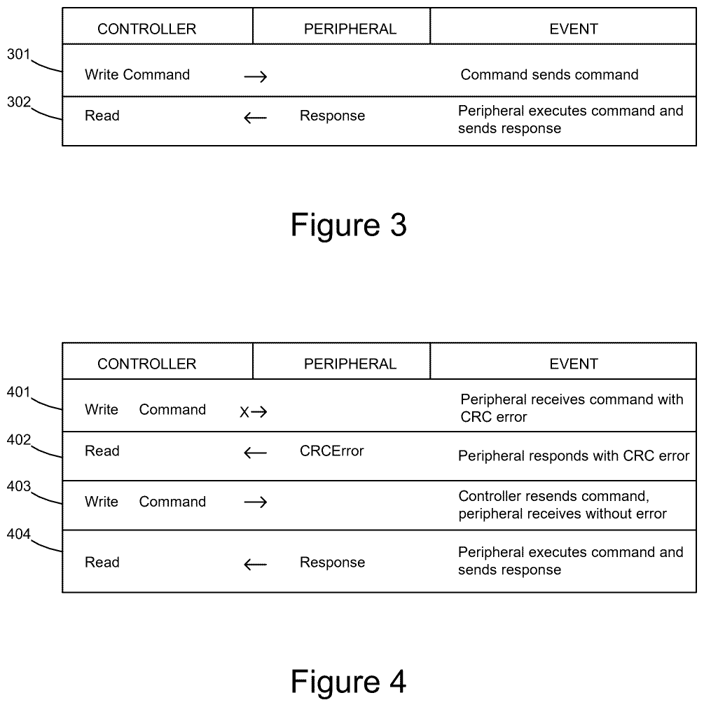

The examples in FIGS. 3, 4, 5 and 6 show a normal transaction and how errors are handled between the controller and the peripheral. The arrows indicate the direction of data transmission. An arrow with no adjacent X indicates an error-free transfer and an arrow with an adjacent X indicates an error. In the examples, Command means the command packet, Response means the expected response packet, CRCError means a response packet with a status of CRC error, and CycleError means a response packet with a status of cycle error.

FIG. 3 shows a normal, successful transaction. At step 301, the controller sends a command message to the peripheral in a packet as shown in FIG. 2C and increments the sequence number at the controller. At step 302, the peripheral receives the command message from the controller, executes the command, increments the sequence number at the peripheral and sends the response to the controller. In practice, this is achieved by the controller reading the response that has been made available for reading by the peripheral.

FIG. 4 shows a transaction in which a CRC error occurs at the peripheral. First, at step 401, the controller sends the command message to the peripheral in a packet as shown in FIG. 2C and increments the sequence number at the controller. The peripheral receives the command message from the controller with a CRC error. This means that when the peripheral performs a CRC of the message, the result does not match the CRC included in the packet which indicates an error has occurred in transferring the packet from the controller to the peripheral as shown by the X adjacent the arrow. At step 402, an error message is sent to the controller. When the controller receives the error message generated by the peripheral, the controller knows that the peripheral did not receive the command properly, so the controller sends the command message again at step 403. This time, the peripheral receives the command message without error and executes the command, increments the sequence number at the peripheral and sends the response to the controller at step 404.

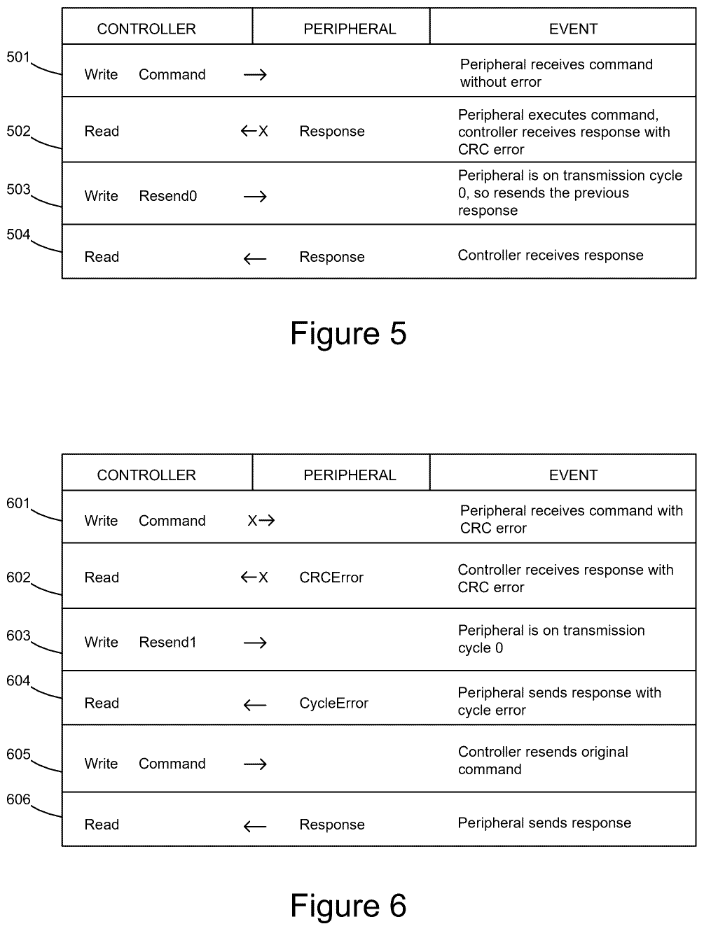

FIG. 5 shows a transaction in which a CRC error occurs at the controller. First, at step 501, the controller sends the command message to the peripheral in a packet as shown in FIG. 2C and increments the sequence number at the controller. The peripheral receives the command message from the controller, executes the command, increments the sequence number at the peripheral and sends the response to the controller at step 502. However, the controller receives the response with a CRC error, indicated by the X in FIG. 5.

At step 503, the controller sends the peripheral a resend request for the response, the resend request includes an indication of whether the sequence number at the first component is odd or even. To implement this, one or more resend commands are provided for the controller to request that the peripheral resend a packet, and the command indicates even or odd, either by selection of a corresponding command or a parameter within the command. In this example, the resend commands Resend0 and Resend1 are used. The controller sends Resend0 for even sequence number values and Resend1 for odd sequence number values.

By the controller not being able to properly read the response from the peripheral, the controller does not know if the peripheral properly received the command or if the peripheral also had a communication failure and has not received the command yet. As in the case of FIG. 5, the peripheral properly received the command, and has therefore executed the command, prepared the response, and incremented the sequence number. Initially the controller assumes the peripheral has received the command and executed on it already, so it sends a Resend request and sequence even/odd based on the command already being executed.

When the indication of whether the sequence number is odd or even matches the sequence number at the peripheral, the peripheral resends the response packet to the controller as shown in steps 503 and 504. This is because the peripheral received the original command without error and executed it, the sequence even/odd in the resend request should match what the peripheral expects, so the peripheral will send its last response again without re-executing the command or incrementing the sequence number at the peripheral. This time, the controller receives the response without error.

FIG. 6 shows a transaction in which a CRC error occurs at the controller and a CRC error occurs at the peripheral. First, at step 601, the controller sends the command message to the peripheral in a packet as shown in FIG. 2C and increments the sequence number at the controller. The peripheral receives the command message from the controller with a CRC error indicated by the first X. So, the peripheral does not execute the command or increment the sequence number. At step 602, an error message is sent to the controller which also arrives at the controller also with a CRC error of its own, indicated by the second X.

At step 603, the controller then sends the peripheral a resend request for the response, the resend request includes an indication of whether the sequence number at the first component is odd or even. However, as the peripheral did not properly receive the command, it has prepared an error response and has not incremented the sequence number. So, a sequence error, otherwise known as a cycle error response (CycleError) is sent to the controller at step 604 to notify the controller that the received resend command does not correspond to its current sequence number. As the peripheral did not receive the original command properly, the sequence even/odd should not match. In this case, the peripheral responds with a sequence error to notify the first component that it never properly received the original command. When the first component receives the sequence error from the second component, the first component knows that the second component also had a communication failure on the original command, so it needs to send the original command again. The resend commands and error responses are sent unencrypted for speed and to avoid issues with invalid MACs and other encryption problems in error situations.

At step 605, the controller resends the last command packet sent from the controller to the peripheral prior to the error. The controller does not increment its sequence number when resending the command. The peripheral receives the command message from the controller, executes the command, increments the sequence number at the peripheral and sends the response to the controller at step 606. The controller and peripheral sequence numbers are now back in sync.

Both the controller and the peripheral keep a copy of the last packet sent. The sequence number increments with every command sent, except for the resend command and for CRC errors. The cycle value is the last bit of the command sequence (i.e., 0 for even values and 1 for odd values of the sequence number). If the cycle value matches when a resend is received, the peripheral resends the last response. If the cycle value does not match when a resend is received, then the peripheral sends CycleError and the controller knows the peripheral didn't receive the initial command and the initial command must be resent.

In the above implementations/embodiments, the various components are configured as leader/follower components. This is purely optional and other communication busses may be used.

It will be understood that the example applications described herein are illustrative and should not be considered limiting. It will be appreciated that the actions described and shown in the example methods may be carried out or performed in any suitable order. It will also be appreciated that not all of the actions described in FIG. 3 to FIG. 6 need to be performed in accordance with the example embodiments of the disclosure and/or additional actions may be performed in accordance with other example embodiments of the disclosure.

Many modifications and other embodiments of the disclosure set forth herein will come to mind to one skilled in the art to which these disclosures pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Further disclosure is provided below.

Statement 1: A method of communicating a message between a first component of an imaging system and a second component of the imaging system in a packet, the method comprising: determining whether a length of the message is equal to or greater than a threshold length, when the length of the message is equal to or greater than the threshold length, communicating the message encrypted between the first and second components of the imaging system, and when the length of the message is smaller than the threshold length, communicating the message unencrypted between the first and second components of the imaging system.

Statement 2: The method of statement 1, wherein, when the message is communicated unencrypted, an unencrypted packet is communicated, the packet comprising the message and, optionally, an error detecting code.

Statement 3: The method of statement 2, wherein, when the unencrypted packet is sent from the second component, the unencrypted packet further comprises a length field indicating the length of the message.

Statement 4: The method of statement 1, wherein, when the message is sent encrypted, an encrypted packet is sent, the encrypted packet comprising encrypted blocks based on the message and, optionally, an error detecting code.

Statement 5: The method of statement 4, wherein, when the encrypted packet is sent from the second component, the encrypted packet further comprises a length field indicating the length of the encrypted blocks.

Statement 6: The method of statement 1, wherein, when a sending component of the first and second component for the message, determines that the message to be communicated requires encryption and the message has a length below the threshold length, the sending component performs a padding operation on the message to increase the length of the message to a padded length equal to or greater than threshold length.

Statement 7: The method of statement 6, wherein, a receiving component of the first and second component for the message, determines that the message communicated contains padding and performs an inverse of the padding operation on the message.

Statement 8: An imaging device comprising a first component, the first component configured to communicate a message in a packet between the first component and a second component, when the second component is installed in the imaging device, wherein the first component is configured to communicate a message in a packet by: determining whether a length of the message is equal to or greater than a threshold length, when the length of the message is equal to or greater than the threshold length, communicating the message encrypted, and when the length of the message is smaller than the threshold length, communicating the message unencrypted.

Statement 9: The imaging device of statement 8, wherein, when the message is communicated unencrypted, an unencrypted packet is sent, the packet comprising the message and, optionally, an error detecting code.

Statement 10: The imaging device of statement 8, wherein, when an unencrypted packet is received at the first component from the second component, the first component is configured to determine a length of the message by reading a length field of the unencrypted packet.

Statement 11: The imaging device of statement 8, wherein, when the message is communicated encrypted, an encrypted packet is communicated, the encrypted packet comprising encrypted blocks based on the message and, optionally, an error detecting code.

Statement 12: The imaging device of statement 11, wherein, when the encrypted packet is received at the first component from the second component, the first component is configured to determine a length of the encrypted blocks of the encrypted packet by reading a length field of the encrypted packet.

Statement 13: The imaging device of statement 8, wherein, when the first component is to send the message and the message has a length below the threshold length, the first component is configured to determine whether the message requires encryption and, when it is determined that the message does require encryption, the first component is configured to perform a padding operation on the message to increase the length of the message to a padded length equal to or greater than threshold length, and when the first component receives the message, the first component is configured to determine whether the message contains padding and, when it is determined that the message does contain padding, the first component is configured to perform an inverse of the padding operation on the message.

Statement 14: A supply item for an imaging device, the supply item comprising a second component, the second component configured to communicate a message in a packet between the second component and a first component of the imaging device, when the second component is installed in the imaging device, wherein the second component is configured to communicate a message in a packet by: determining whether a length of the message is equal to or greater than a threshold length, when the length of the message is equal to or greater than the threshold length, communicating the message encrypted, and when the length of the message is smaller than the threshold length, communicating the message unencrypted.

Statement 15: The supply item of statement 14, wherein, when the message is communicated unencrypted, an unencrypted packet is communicated, the packet comprising the message and, optionally, an error detecting code.

Statement 16: The supply item of statement 15, wherein, when the unencrypted packet is sent from the second component, the second component is configured to include in the packet, a length field indicating the length of the message.

Statement 17: The supply item of statement 14, wherein, when the message is sent encrypted, an encrypted packet is communicated, the encrypted packet comprising encrypted blocks based on the message and, optionally, an error detecting code.

Statement 18: The supply item of statement 17, wherein, when the encrypted packet is sent from the second component, the second component is configured to include in the packet a length field indicating the length of the encrypted blocks.

Statement 19: The supply item of statement 14, wherein, when the second component is to send the message and the message has a length below the threshold length, the second component is configured to determine whether the message requires encryption and, when it is determined that the message does require encryption, the second component is configured to perform a padding operation on the message to increase the length of the message to a padded length equal to or greater than threshold length, and when the second component receives the message, the second component is configured to determine whether the message contains padding and, when it is determined that the message does contain padding, the second component is configured to perform an inverse of the padding operation on the message.

Statement 20: An imaging system comprising the supply item of claim 14 installed in the imaging device of statement 8.

What is claimed is:

1. A method of communicating messages between a first component of an imaging system and a second component of the imaging system within a communication session, the method comprising:
initialising a sequence number at the first component and at the second component at the beginning of the communication session,
for each message communicated in the communication session:
when the message is a command message, incrementing a value of the sequence number at the first component and at the second component,
communicating a packet comprising the message between the first component and the second component, and, when the message is encrypted, an indication of the sequence number,
wherein the value of the sequence number is unique for each command message in the communication session.

2. The method of claim 1, wherein when an error occurs in communicating one of the packets to the second component, an error message is sent to the first component, and the first component resends the packet to the second component.

3. The method of claim 1, wherein when an error occurs in communicating one of the packets to the first component, the first component sends the second component a resend request for the packet, the resend request comprising an indication of whether the sequence number is odd or even.

4. The method of claim 3, wherein when the indication of whether the sequence number is odd or even matches the sequence number at the second component, the second component resends the packet to the first component, and when the indication of whether the sequence number is odd or even does not match the sequence number at the second component, the second component sends a sequence error message to the first component and the first component resends the last command packet sent from the first component to the second component prior to the error.

5. The method of claim 2, wherein the error message is sent unencrypted.

6. The method of claim 4, wherein the resend request and sequence error message are sent unencrypted.

7. The method of claim 1, wherein, for messages that are encrypted, the indication of the sequence number comprises a Message Authentication Code (MAC) based on the sequence number and the message.

8. The method of claim 7 wherein the MAC is further based on a MAC key.

9. The method of claim 8 wherein the MAC is calculated using the MAC key on the message with appended sequence number.

10. The method of claim 7 wherein the MAC is calculated by performing a hash, HMAC, KMAC, UMAC, or Poly1305.

11. The method of claim 1, wherein the sequence number comprises 16 bits.

12. The method of claim 1, the method further comprising ending the communication session when the sequence number reaches a maximum value of the sequence number.

13. An imaging device comprising a first component, the first component configured to communicate messages within a communication session between the first component and a second component, when the second component is installed in the imaging device, the first component configured to:
initialise a sequence number at the first component at the beginning of the communication session,
for each message communicated in the communication session:
when the message is a command message, incrementing a value of the sequence number at the first component,
communicating a packet comprising the message between the first component and the second component, and, when the message is encrypted, an indication of the sequence number,
wherein the value of the sequence number is unique for each command message in the communication session.

14. The imaging device of claim 13, wherein when the first component receives an error message from the second component, the first component is configured to resend the packet to the second component.

15. The imaging device of claim 13, wherein when an error occurs in communicating one of the packets to the first component, the first component is configured to send the second component a resend request for the packet, the resend request comprising an indication of whether the sequence number is odd or even.

16. The imaging device of claim 15, wherein when the first component receives a sequence error message, the first component is configured to resend the last command packet sent by the first component to the second component prior to the error.

17. The imaging device of claim 13, the first component configured to end the communication session when the sequence number reaches a maximum value of the sequence number.

18. A supply item for an imaging device, the supply item comprising a second component, the second component configured to communicate messages within a communication session between the second component and a first component of the imaging device, when the second component is installed in the imaging device, wherein the second component is configured to communicate messages within a communication session by:
initialising a sequence number at the second component at the beginning of the communication session,
for each message communicated in the communication session:
when the message is a command message, incrementing a value of the sequence number at the second component,
communicating a packet comprising the message between the first component and the second component, and, when the message is encrypted, an indication of the sequence number,
wherein the value of the sequence number is unique for each command message in the communication session.

19. The supply item of claim 18, wherein the second component is configured to:
send an error message to the first component when an error occurs in communicating one of the packets to the second component, and/or
determine whether an indication of whether the sequence number is odd or even matches the sequence number at the second component, when the second component receives a resend request for the packet, the resend request comprising the indication of whether the sequence number is odd or even, and,
resend the packet to the first component when the indication of whether the sequence number is odd or even is determined to match the sequence number at the second component, and
sends a sequence error message to the first component when the indication of whether the sequence number is odd or even does not match the sequence number at the second component.

20. An imaging system comprising the supply item of claim 18 installed in the imaging device of claim 13.
